(19) United States
(12) Patent Application Publication
(10) Pub. No.: US 2024/0388160 A1
(43) Pub. Date: Nov. 21, 2024

(54) MOTOR

(71) Applicant: LG INNOTEK CO., LTD., Seoul (KR)

(72) Inventors: Sun Woo HAN, Seoul (KR); Geon Hyeong LEE, Seoul (KR); Tae Ho KIM, Seoul (KR)

(21) Appl. No.: 18/693,218

(22) PCT Filed: Nov. 4, 2022
(86) PCT No.: PCT/KR2022/017224

§ 371 Date: Mar. 19, 2024

(30) Foreign Application Priority Data
Nov. 18, 2021 (KR) 10-2021-0159213
Dec. 10, 2021 (KR) 10-2021-0176392

(51) Int. Cl. H02K 3/52

(52) U.S. Cl. CPC H02K 3/522; H02K 2203/09

(57) ABSTRACT

Disclosed, in an embodiment, is a motor comprising: a stator; a rotor disposed inside the stator; a shaft coupled to the rotor; and a bus bar disposed on the stator. The bus bar includes a bus bar holder and a plurality of terminals disposed on the bus bar holder. Each of the terminals includes a body disposed in the bus bar holder, an extension part extending inwardly from the body, and a protrusion part protruding in the axial direction from the end of the extension part. The body, the extension part, and the protrusion part are integrated. The body of each of the terminals is disposed on the same virtual plane, and the protrusion part of each of the terminals is disposed so as to be exposed from the bus bar holder.

### TECHNICAL FIELD

Embodiments relate to a motor.

### BACKGROUND ART

A motor is a device for converting electrical energy into rotational energy using a force received by a conductor in a magnetic field. Recently, as the use of the motor has expanded, the role of the motor has become more important. In particular, as the electrification of vehicles progresses rapidly, the demand for motors applied to steering systems, braking systems, design systems, and the like is increasing significantly.

The motor may include a housing, a cover disposed in an opening of the housing, a shaft, a rotor installed on an outer circumferential surface of the shaft, a stator disposed to correspond to the rotor, a bus bar disposed above the stator, and the like. Here, the stator causes electrical interaction with the rotor to induce the rotation of the rotor. Therefore, the shaft coupled with the rotor also rotates.

In addition, the bus bar may include a bus bar body and a plurality of terminals disposed on the bus bar body. Here, one side of the terminal may be connected to a connection end of a coil of the stator, and the other side may be connected to an external power source. In this case, the bus bar may be formed through an injection molding method.

Meanwhile, since the terminal is implemented in a complicated shape for electrical connection with the coil and the external power source, there is a problem in that a large amount of scrap is generated. For example, since the terminal may include a hook-shaped fastening part for fusing with the coil, there is a problem in that a large amount of scrap is formed due to a structure.

In addition, since the plurality of terminals are formed in a stacked structure in an axial direction, there is a problem in that an axial thickness of the bus bar increases. For example, considering a location of the fastening part while maintaining a gap between the terminals for physical and electrical separation, the terminals are formed in a stacked structure in the axial direction. Therefore, there is a limit in implementing a compact-sized bus bar.

Therefore, the optimized design and arrangement of the terminal are being requested to implement a compact bus bar by reducing the thickness of the bus bar while minimizing the generation of scrap.

### DISCLOSURE

### Technical Problem

Embodiments are directed to providing a motor including a bus bar terminal formed to minimize the generation of scrap while implementing a compact bus bar.

The embodiments are directed to providing a motor which can have a simplified manufacturing process of a bus bar and reduce scrap discarded during the manufacturing process of the bus bar.

Objects of the embodiments are not limited to the above-mentioned objects, and other objects which are not mentioned herein will be clearly understood by those skilled in the art from the following descriptions.

### Technical Solution

The object is achieved by a motor including a stator, a rotor disposed inside the stator, a shaft coupled to the rotor, and a bus bar disposed on the stator, wherein the bus bar includes a bus bar holder and a plurality of terminals disposed on the bus bar holder, each of the terminals includes a body disposed in the bus bar holder, an extension part extending inward from the body, and a protrusion part protruding in an axial direction from an end portion of the extension part, the body, the extension part, and the protrusion part are formed integrally, the body of each of the terminals is disposed on the same virtual plane, and the protrusion part of each of the terminals is disposed to be exposed from the bus bar holder.

Here, the plurality of terminals may include a first terminal, a second terminal, and a third terminal disposed to be spaced apart from each other, the first terminal may include an arc-shaped first body, a first extension part extending inward from the end portion of the first body, a first protrusion part extending from an end portion of the first extension part in the axial direction, and a plurality of first terminal holes formed in the first body, the second terminal may include an arc-shaped second body, a second extension part extending inward from the end portion of the second body, a second protrusion part extending from an end portion of the second extension part in the axial direction, and a plurality of second terminal holes formed in the second body, and the third terminal may include an arc-shaped third body, a third extension part extending inward from the end portion of the third body, a third protrusion part extending from an end portion of the third extension part in the axial direction, and a plurality of third terminal holes formed in the third body.

In addition, each of the terminals may further include a boss part extending the terminal hole.

An embodiment may provide a motor including a shaft, a rotor coupled to the shaft, a stator disposed to correspond to the rotor and including a stator core, an insulator coupled to the stator core, and a coil disposed on the insulator, and a terminal electrically connected to the coil, wherein the terminal includes a first body part, and a second body part coupled to the first body part, the second body part includes a plurality of grooves, the first body part is coupled to any one of the plurality of grooves, and the plurality of grooves have the same shape.

An embodiment may provide a motor including a shaft, a rotor coupled to the shaft, a stator disposed to correspond to the rotor and including a stator core, an insulator coupled to the stator core, and a coil disposed on the insulator, and a terminal electrically connected to the coil, wherein the terminal includes a first body part in contact with the coil, and a second body part in contact with an external device and coupled to the first body part, and the second body part includes a groove disposed to be spaced apart from the first body part.

Preferably, the second body part may include a terminal body, and a terminal part bent outward at both end portions of the terminal body and in contact with the coil, the terminal body may include a pair of protrusions protruding from an upper surface of the terminal body, and the groove may be defined as a space between the pair of protrusions.

Preferably, one side surface of any one of the pair of protrusions and one side surface of the body may be disposed on the same plane.

Preferably, the motor may further include a bus bar holder configured to support the terminal, and the protrusion may be disposed to protrude from one surface of the bus bar holder.

Preferably, the second body part may include a terminal body, and terminal parts bent at both end portions of the terminal body and in contact with the coil, the groove may include a first groove disposed on one end portion of the terminal body, and a second groove disposed on the other end portion of the terminal body, and the first body part may be coupled to only any one of the first groove and the second groove.

Preferably, the first body part may include a middle portion, and one end portion disposed at one side of the middle portion, the one end portion may have a larger width than the middle portion, both side walls of the groove may include a latching groove concavely formed inward, and the one end portion may be coupled to the latching groove.

Preferably, the plurality of terminals may be classified into a first group and a second group disposed to be spatially separated and disposed to be separated in circuitry, a plurality of grooves disposed in the first group may be disposed not to overlap each other in a radial direction, and a plurality of grooves disposed in the second group may be disposed not to overlap each other in the radial direction.

### Advantageous Effects

According to the embodiments, it is possible to implement the compact bus bar using the plurality of terminals which maintain the separation distance between the terminals while some are disposed on the same plane. Specifically, it is possible to reduce the axial size of the bus bar through the body of each of the plurality of terminals disposed on the same plane.

According to the embodiments, it is possible to minimize the scrap generated when the plurality of terminals are formed by using a method of cutting and molding one plate.

According to the embodiments, since the electrical coupling with the coil is implemented through the hole formed in the body, it is possible to minimize the generation of the scrap while implementing the compact-sized bus bar. Specifically, according to the embodiments, since a separate structure, such as a fastening part used for the conventional terminal, is not implemented, it is possible to implement the compact-sized bus bar and at the same time, minimize the generation of the scrap minimally using the plate. Here, the fastening part can indicate a hook-shaped structure provided for the fusing processing with the coil.

According to the embodiments, by forming the first body part connected to the external device in a linear shape and forming the first body part to be coupled to the second body part, it is possible to greatly reduce the scrap generated in the manufacturing process of the terminal.

According to the embodiments, by forming the plurality of grooves to which the first body part connected to the external device can be coupled in the second body part and identically forming the shapes of the grooves to couple the second body part to any one of the plurality of grooves corresponding to the connection location of the external device, it is possible to commonly use the terminal.

According to the embodiments, it is possible to simplify the manufacturing process by identically forming the shapes of the plurality of terminals.

Various and beneficial advantages and effects of the embodiments are not limited to the above-described contents and will be more easily understood in a process of describing the specific implementation forms of the embodiments.

### DESCRIPTION OF DRAWINGS

FIG. 1 is a view illustrating a motor according to an embodiment.

FIG. 2 is a perspective view illustrating a bus bar of a motor according to a first embodiment.

FIG. 3 is a plan view illustrating the bus bar of the motor according to the first embodiment.

FIG. 4 is a cross-sectional view along line A-A in FIG. 3.

FIG. 5 is a view illustrating a plurality of terminals cut from one plate.

FIG. 6 is a perspective view illustrating a terminal of the bus bar disposed on the motor according to the first embodiment.

FIG. 7 is a plan view illustrating the terminal of the bus bar of the motor according to the first embodiment.

FIG. 8 is a cross-sectional view along line B-B in FIG. 7.

FIG. 9 is a perspective view illustrating a first terminal of the bus bar disposed on the motor according to the first embodiment.

FIG. 10 is a plan view illustrating the first terminal of the bus bar disposed on the motor according to the first embodiment.

FIG. 11 is a perspective view illustrating a second terminal of the bus bar disposed on the motor according to the first embodiment.

FIG. 12 is a plan view illustrating the second terminal of the bus bar disposed on the motor according to the first embodiment.

FIG. 13 is a perspective view illustrating a third terminal of the bus bar disposed on the motor according to the first embodiment.

FIG. 14 is a plan view illustrating the third terminal of the bus bar disposed on the motor according to the first embodiment.

FIG. 15 is a cross-sectional view illustrating a modified example of the terminal of the bus bar disposed on the motor according to the first embodiment.

FIG. 16 is a view schematically illustrating the motor according to the embodiment.

FIG. 17 is a view illustrating a stator on which a terminal, bus bar holder, and cap of a motor according to a second embodiment are mounted.

FIG. 18 is a perspective view illustrating the terminal and the bus bar holder of the motor according to the second embodiment.

FIG. 19 is a view illustrating a terminal mounted on the bus bar holder of the motor according to the second embodiment.

FIG. 20 is a plan view illustrating terminals disposed on the motor according to the second embodiment.

FIG. 21 is a plan view of the bus bar holder disposed on the motor according to the second embodiment.

FIG. 22 is a view illustrating a fourth terminal of the motor according to the second embodiment.

FIG. 23 is a perspective view illustrating first, second, and third terminals of the motor according to the second embodiment.

FIG. 24 is a front view illustrating the first, second, and third terminals of the motor according to the second embodiment.

FIG. 25 is a view illustrating a plate for molding a terminal.

FIG. 26 is a view illustrating a terminal in which a first body part is disposed in a first groove.

FIG. 27 is a view illustrating a terminal in which the first body part is disposed in a second groove.

FIG. 28 is a perspective view of the terminal viewed in another direction.

### MODE FOR INVENTION

Hereinafter, embodiments will be described in detail with reference to the accompanying drawings. However, the present invention is not limited to some embodiment, but can be implemented in various different forms and used by selectively coupling and substituting one or more among components between the embodiments.

In addition, when a first component is formed or disposed “above (on) or under (below) a second component, the term “above (on) or under (below)” includes not only a case in which two components are in direct contact with each other but also a case in which one or more other components are formed or disposed between the two components. In addition, in the case of being expressed as the “above (on) or under (below),” it may include the meanings of a downward direction as well as an upward direction with respect to one component.

Hereinafter, embodiments will be described in detail with reference to the accompanying drawings, the same or corresponding components are denoted by the same reference numeral regardless of the drawing symbols, and overlapping descriptions thereof will be omitted.

### First Embodiment

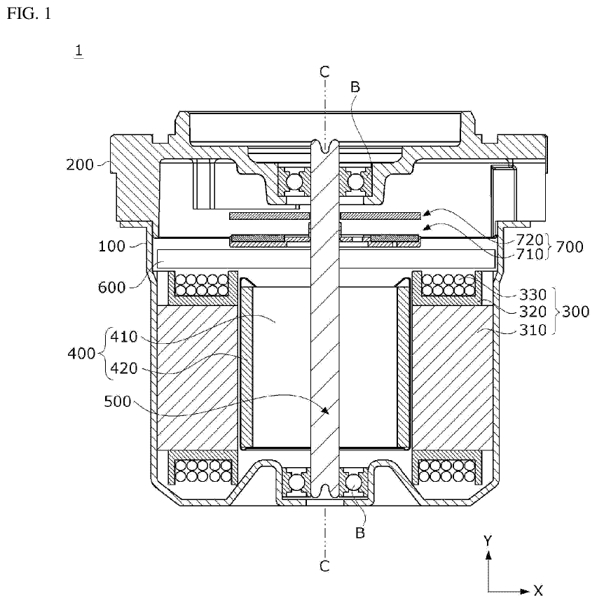

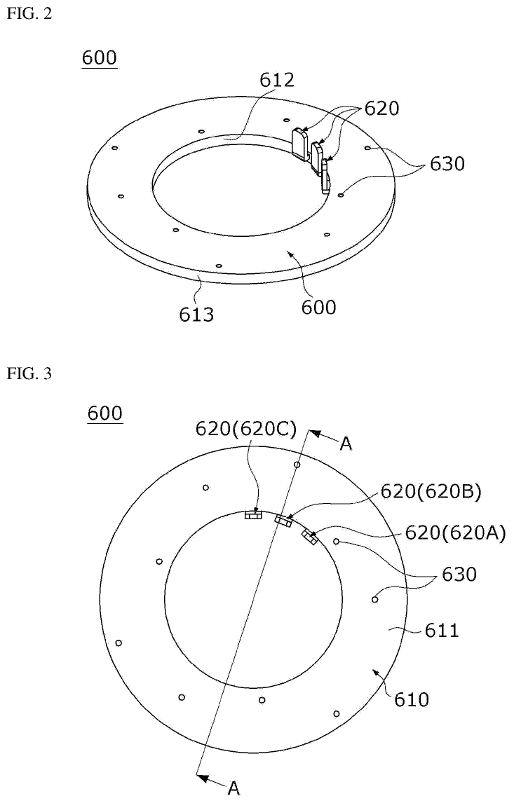

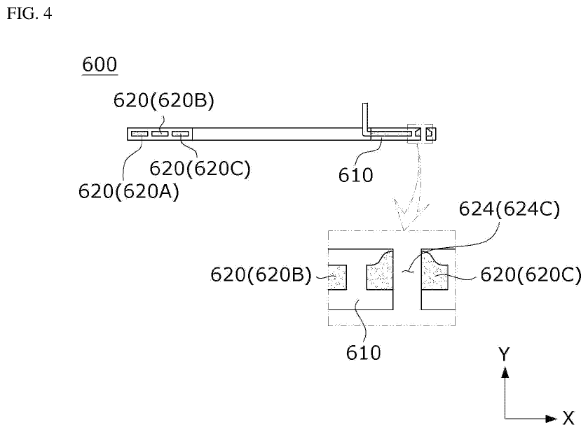

FIG. 1 is a view illustrating a motor according to an embodiment, FIG. 2 is a perspective view illustrating a bus bar of a motor according to a first embodiment, FIG. 3 is a plan view illustrating the bus bar of the motor according to the first embodiment, and FIG. 4 is a cross-sectional view along line A-A in FIG. 3.

Here, an X direction illustrated in FIG. 1 may indicate a radial direction, and a Y direction may indicate an axial direction. In addition, the axial direction may be perpendicular to the radial direction. In addition, a direction along a circle with a radial radius with respect to the center of axis may be referred to as a circumferential direction. In addition, the reference numeral “C” illustrated in FIG. 1 may denote the center of rotation (center of axis).

Referring to FIG. 1, the motor according to the first embodiment may include a housing 100 having an opening formed in one side thereof, a cover 200 disposed by being inserted into the housing 100 through the opening, a stator 300 disposed inside the housing 100, a rotor 400 disposed inside the stator 300, a shaft 500 coupled to the rotor 400, and a bus bar 600 disposed above the stator 300. Here, the inside may indicate a direction disposed toward a rotation center C of the motor with respect to a radial direction, and the outside may indicate a direction opposite to the inside.

In addition, the motor may include a sensor unit 700 for detecting the rotation of the shaft 500.

The housing 100 and the cover 200 may form an exterior of the motor. In addition, an accommodation space may be formed inside the housing 100 and the cover 200 by coupling the housing 100 to the cover 200. Therefore, as illustrated in FIG. 1, the stator 300, the rotor 400, the shaft 500, the bus bar 600, and the like may be disposed in the accommodation space.

In this case, the shaft 500 is rotatably disposed in the accommodation space. Therefore, the motor may further include a bearing B disposed on each of upper and lower portions of the shaft 500. Here, the bearing B disposed on the housing 100 may be referred to as a first bearing or housing bearing, and the bearing B disposed on the cover 200 may be referred to as a second bearing or cover bearing.

The housing 100 may be formed in a cylindrical shape and may form the exterior of the motor. In addition, the housing 100 may accommodate the cover 200, the stator 300, the rotor 400, and the like therein. In this case, a shape or material of the housing 100 may be changed variously. For example, the housing 100 may be made of a metal material, such as aluminum capable of withstanding high temperatures.

The cover 200 may be disposed on an opening surface of the housing 100, that is, an upper portion of the housing 100, to cover the opening of the housing 100. Here, a shape or material of the cover 200 may be changed variously. For example, the cover 200 may be made of a metal material capable of withstanding high temperatures.

In addition, the bearing B is disposed on the cover 200 to rotatably support the shaft 500.

Referring to FIG. 1, the stator 300 may include a stator core 310, an insulator 320 disposed on the stator core 310, and a coil 330 wound around the insulator 320.

The coil 330 generating a rotational magnetic field may be wound around the stator core 310. Here, the stator core 310 may be formed of a single core or formed by coupling a plurality of split cores.

The stator core 310 may be formed in a shape in which a plurality of thin steel plates are stacked, but is not limited thereto. For example, the stator core 310 may be formed as a single product.

The stator core 310 may include a cylindrical yoke (not illustrated) and a plurality of teeth (not illustrated) protruding from the yoke in the radial direction.

The plurality of teeth may be disposed to be spaced apart from each other in a circumferential direction of the yoke. Therefore, a slot, which is a space in which the coil 330 is wound, may be formed between the teeth.

Meanwhile, the teeth of the stator 300 may be disposed to have an air gap with the rotor 400. Here, the air gap may be a distance between the teeth and a magnet 420 in the radial direction.

The insulator 320 insulates the stator core 310 and the coil 330. Therefore, the insulator 320 may be disposed between the stator core 310 and the coil 330.

Therefore, the coil 330 may be wound around the stator core 310 on which the insulator 320 is disposed.

The rotor 400 is rotated by the electrical interaction with the stator 300. In this case, the rotor 400 may be rotatably disposed on the stator 300.

Referring to FIG. 1, the rotor 400 may include a rotor core 410 and a plurality of magnets 420 disposed outside the rotor core 410. In other words, the rotor 400 may be formed in a surface permanent magnet (SPM) type in which the magnet 420 is attached to a surface of the rotor core 410. In this case, the magnet 420 may be disposed to be spaced by a predetermined interval from the rotor core 410 in the circumferential direction with respect to the center C.

In addition, the rotor 400 may further include a can for protecting the rotor core 410 and the magnet 420. In this case, the can may be disposed to cover the rotor core 410 to which the magnet 420 is coupled.

The rotor core 410 may be implemented in a shape in which a plurality of thin steel plates are stacked or implemented in one cylindrical shape.

In addition, the rotor core 410 may be formed in a cylindrical shape, and a hole to which the shaft 500 is coupled may be formed at the center C.

The magnet 420 forms a rotating magnetic field with the coil 330 wound around the stator core 310 of the stator 300. Therefore, the rotor 400 is rotated by the electrical interaction between the coil 330 and the magnet 420, and the shaft 500 rotates in conjunction with the rotation of the rotor 400 to generate a driving force of the motor. Here, the magnet 420 of the rotor 400 may be referred to as a drive magnet.

A plurality of magnets 420 may be disposed to be spaced apart from each other in the circumferential direction on an outer circumferential surface of the rotor core 410.

The shaft 500 may be rotatably disposed inside the housing 100 by the bearing B. In addition, the shaft 500 may rotate in conjunction with the rotation of the rotor 400.

In addition, the shaft 500 may be coupled to the hole formed at the center of the rotor core 410 in a press-fitting method.

The bus bar 600 may be disposed above the stator 300.

In addition, the bus bar 600 may be electrically connected to the coil 330 of the stator 300. In addition, the bus bar 600 may be electrically connected to an external power transmission device, such as a connector, through the hole or the like formed in the cover 200.

Referring to FIGS. 2 to 4, the bus bar 600 may include a bus bar holder 610, a plurality of terminals 620 disposed on the bus bar holder 610, and a plurality of bus bar holes 630 formed to pass therethrough in the axial direction. Here, the bus bar holder 610 may be referred to as a bus bar body. In addition, the bus bar hole 630 may be referred to as a first hole.

The bus bar holder 610 may be formed in a plate shape with a predetermined axial thickness.

In addition, the bus bar holder 610 may be formed in an annular shape in which a hole is formed to pass through the center in the axial direction. Therefore, the bus bar body may include an inner circumferential surface 612 and an outer circumferential surface 613.

In addition, the bus bar holder 610 may be made of a synthetic resin material such as resin. In addition, the bus bar holder 610 may be formed through an injection molding method. For example, the bus bar 600 may be formed in a method of injecting mold into a plurality of terminals 620 to form the bus bar holder 610.

In other words, the bus bar holder 610 may be a mold material formed through injection molding, which is made of an insulating material. In addition, since a space between the terminals 620 is filled with the mold material during injection molding of the bus bar holder 610, it is possible to secure insulation performance. Therefore, the bus bar holder 610 may physically and electrically separate the plurality of terminals 620.

The terminal 620 may electrically connect the coil 330 of the stator 300 to an external power source. For example, the terminal 620 may connect the coil 330 to the external power source using a terminal hole 624 and a protrusion part 623 of which a portion is exposed from the bus bar holder 610. Here, the terminal 620 may be made of a metal material.

Meanwhile, the plurality of terminals 620 may be formed using one plate.

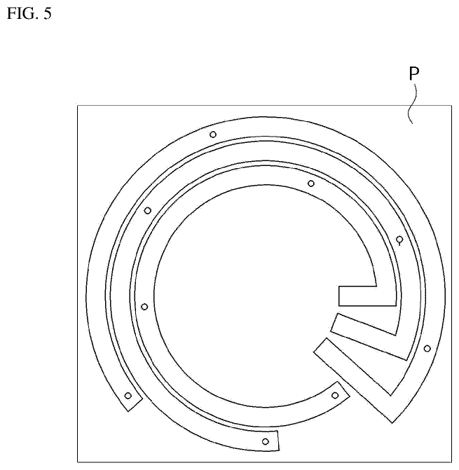

FIG. 5 is a view illustrating a plurality of terminals cut from one plate.

Referring to FIG. 5, a design (diagram) for forming the plurality of terminals 620 on one plate P. In this case, the design for arranging the plurality of terminals is provided to minimize the generation of scrap. In addition, the plurality of terminals 620 may be formed by using a molding method of cutting and bending the one plate P.

As illustrated in FIG. 5, by creating the terminal design to implement a structure in which the terminals are disposed on the same virtual plane, it is possible to minimize the scrap generated from the one plate P. In addition, since the plurality of terminals 620 may be formed from the one plate P, it is possible to simplify the production process. Therefore, it is possible to improve the productivity of the terminal 620.

Each of the plurality of terminals 620 may include a body 621 disposed in the bus bar holder 610, an extension part 622 extending inward from the body 621, and the protrusion part 623 protruding in the axial direction from an end of the extension part 622.

In addition, each of the terminals 620 may include the terminal hole 624 formed to pass therethrough in the axial direction in the body 621. Here, the terminal hole 624 may be referred to as a second hole.

In addition, the terminal 620 may further include a boss part 625 extending the terminal hole 624 in the axial direction.

In this case, the body 621, the extension part 622, and the protrusion part 623 may be formed integrally because they are formed by cutting and bending the one plate P.

The bodies 621 of each of the terminals 620 may be disposed to be spaced apart from each other in the radial direction on the same virtual plane. Therefore, it is possible to reduce an axial size of the bus bar 600.

The protrusion part 623 of each of the terminals 620 may be disposed to be exposed from the bus bar holder 610. Therefore, the protrusion part 623 may be electrically connected to the external power source. In this case, the protrusion part 623 may be disposed inward more than the inner circumferential surface 612 of the bus bar holder 610 and formed to protrude in the axial direction more than the upper surface 611 of the bus bar holder 610. Therefore, it is possible to reduce a radial size of the bus bar 600.

In addition, the protrusion part 623 of each of the terminals 620 may be disposed on a virtual circle CL with a predetermined radius R with respect to the center C. For example, a center C1 of a first protrusion part 623A, a center C2 of a second protrusion part 623B, and a center C3 of a third protrusion part 623C may be disposed on the circle CL.

The terminal hole 624 may be formed in the body 621, and a portion of the coil 330 may be disposed inside the terminal hole 624 to pass through and in contact with the terminal hole 624. In this case, the terminal hole 624 may be disposed to communicate with the bus bar hole 630. Specifically, the terminal hole 624 may form a portion of the bus bar hole 630. In addition, the hole formed in the bus bar holder 610 is formed in the remaining area of the bus bar hole 630.

The boss part 625 may extend the hole 624 in the axial direction. Therefore, it is possible to increase a contact area of the coil 330.

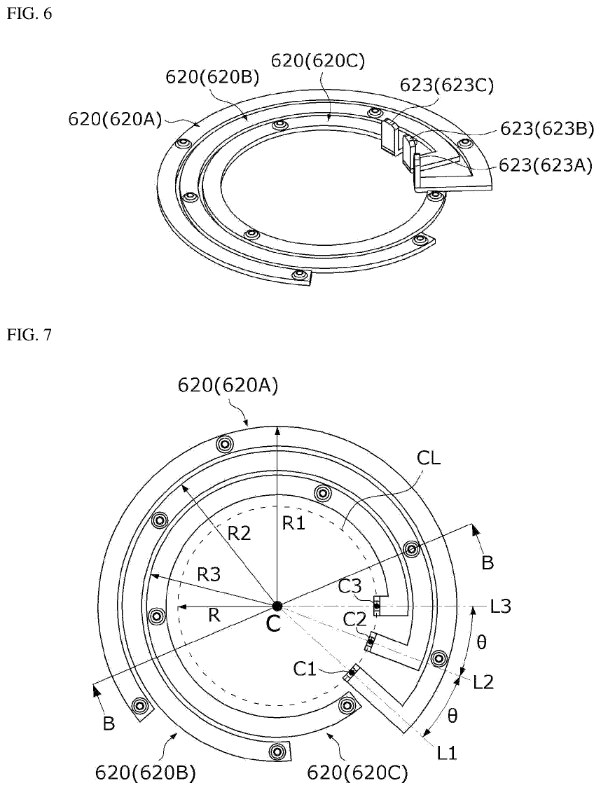

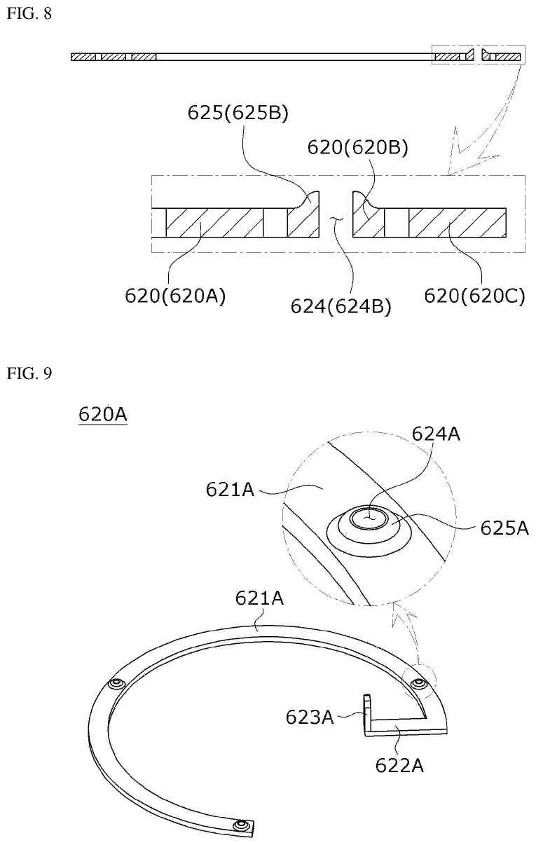

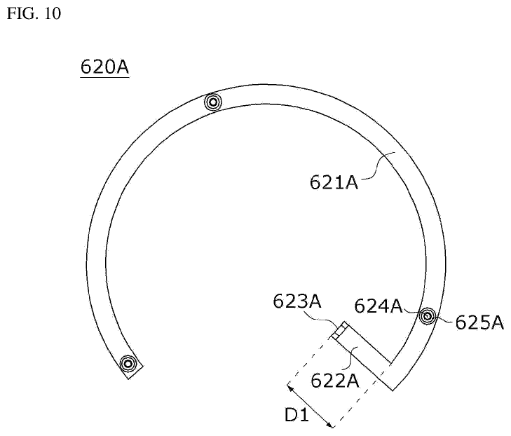

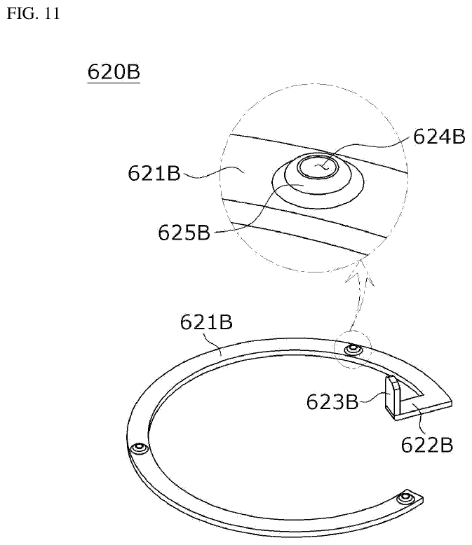

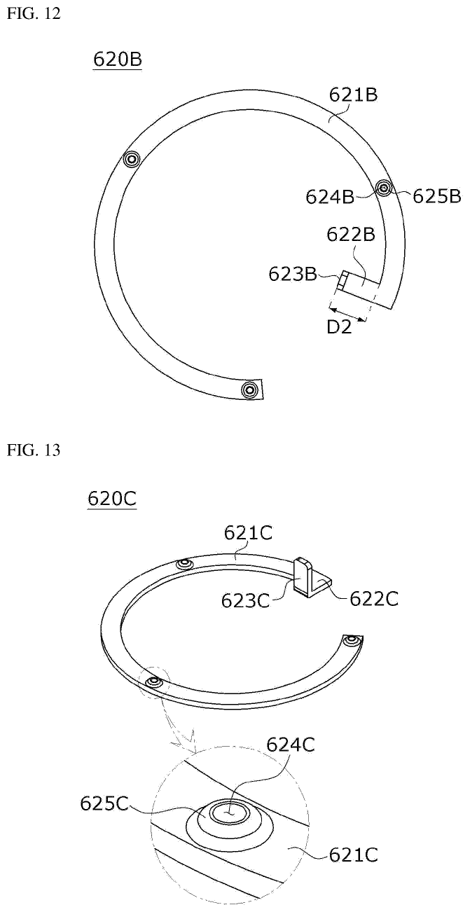

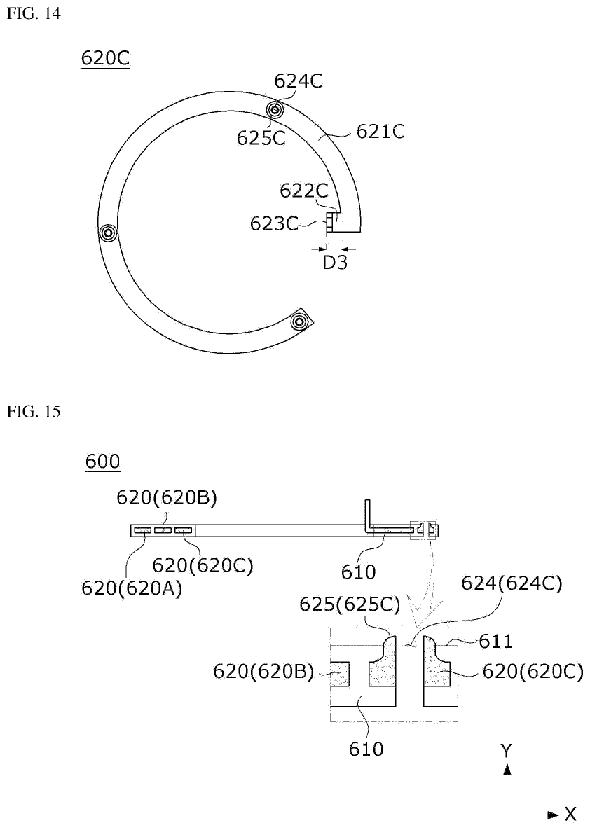

FIG. 6 is a perspective view illustrating a terminal of the bus bar disposed on the motor according to the first embodiment, FIG. 7 is a plan view illustrating the terminal of the bus bar of the motor according to the first embodiment, FIG. 8 is a cross-sectional view along line B-B in FIG. 7, FIG. 9 is a perspective view illustrating a first terminal of the bus bar disposed on the motor according to the first embodiment, FIG. 10 is a plan view illustrating the first terminal of the bus bar disposed on the motor according to the first embodiment, FIG. 11 is a perspective view illustrating a second terminal of the bus bar disposed on the motor according to the first embodiment, FIG. 12 is a plan view illustrating the second terminal of the bus bar disposed on the motor according to the first embodiment, FIG. 13 is a perspective view illustrating a third terminal of the bus bar disposed on the motor according to the first embodiment, and FIG. 14 is a plan view illustrating the third terminal of the bus bar disposed on the motor according to the first embodiment.

Referring to FIGS. 6 to 14, the plurality of terminals 620 may include a first terminal 620A, a second terminal 620B, and a third terminal 620C. In addition, an external power source for implementing any one of U, V, and W phases may be connected to each of the first terminal 620A, the second terminal 620B, and the third terminal 620C. Therefore, the motor can implement a three-phase motor classified into U, V, and W.

The first terminal 620A, the second terminal 620B, and the third terminal 620C may be disposed to be spaced apart from each other. In addition, a portion of the bus bar holder 610 may be disposed between the first terminal 620A, the second terminal 620B, and the third terminal 620C to insulate the terminals 620A, 620B, and 620C. For example, the terminal 620 may include the first terminal 620A and the second terminal 620B disposed to be spaced apart from the first terminal 620A in the radial direction. In addition, the terminal 620 may include the third terminal 620C disposed to be spaced apart outward from the second terminal 620B in the radial direction. In addition, since the portion of the bus bar holder 610 is disposed between the first terminal 620A, the second terminal 620B, and the third terminal 620C, the first terminal 620A, the second terminal 620B, and the third terminal 620C may be insulated.

The first terminal 620A may include a first body 621A, a first extension part 622A extending inward from one end portion of the first body 621A, a first protrusion part 622A extending upward in the axial direction from an end portion of the first extension part 622A, and a plurality of first terminal holes 624A formed to pass therethrough in the axial direction in the first body 621A. In addition, the first terminal 620A may further include a first boss part 625A extending the first terminal hole 624A in the axial direction.

The first body 621A may be formed in an arc shape with a predetermined first radius R1. Therefore, the one end portion and the other end portion of the first body 621A may be disposed to be spaced apart from each other with respect to the circumferential direction. Here, the first radius R1 may be a distance from the center C to an outer surface of the first body 621A and may be referred to as the first radius.

In addition, the first body 621A may be surrounded by the bus bar holder 610.

The first extension part 622A may be disposed to extend inward in the radial direction from the one end portion of the first body 621A. In this case, the first extension part 622A may be formed to have a first length D1.

The first protrusion part 623A may be formed to protrude upward in the axial direction from the one end portion of the first extension part 622A. Therefore, the first protrusion part 623A may be disposed to overlap a portion of the first extension part 622A in the axial direction. Here, the first protrusion part 623A may be referred to as a first terminal part.

Three first terminal holes 624A may be formed in the first body 621A. Therefore, a portion of the coil 330 may be disposed to pass through the first terminal hole 624A inside the first terminal hole 624A.

The first boss part 625A may be formed to protrude from an upper surface of the first body 621A. The upper surface of the first body 621A may be one surface of the first body 621A disposed toward the cover 200.

The second terminal 620B may include a second body 621B, a second extension part 622B extending inward from one end portion of the second body 621B, a second protrusion part 623B extending upward in the axial direction from an end portion of the second extension part 622B, and a plurality of second terminal holes 624B formed to pass therethrough in the axial direction in the second body 621B. In addition, the second terminal 620B may further include a second boss part 625B extending the second terminal hole 624B in the axial direction.

The second body 621B may be formed in an arc shape with a predetermined second radius R2. Therefore, the one end portion and the other end portion of the second body 621B may be disposed to be spaced apart from each other with respect to the circumferential direction. Here, the second radius R2 may be a distance from the center C to an outer surface of the second body 621B and may be referred to as the second radius. In addition, the second radius R2 is smaller than the first radius R1.

In addition, the second body 621B may be surrounded by the bus bar holder 610.

The second extension part 622B may be disposed to extend inward in the radial direction from the one end portion of the second body 621B. In this case, the second extension part 622B may be formed to have a second length D2. In addition, the second length D2 is smaller than the first length D1.

The second protrusion part 623B may be formed to protrude upward in the axial direction from the one end portion of the second extension part 622B. Therefore, the second protrusion part 623B may be disposed to overlap a portion of the second extension part 622B in the axial direction. Here, the second protrusion part 623B may be referred to as a second terminal part.

Three second terminal holes 624B may be formed in the second body 621B. Therefore, a portion of the coil 330 may be disposed to pass through the second terminal hole 624B inside the second terminal hole 624B.

The second boss part 625B may be formed to protrude from an upper surface of the second body 621B. The upper surface of the second body 621B may be one surface of the second body 621B disposed toward the cover 200.

The third terminal 620C may include a third body 621C, a third extension part 622C extending inward from one end portion of the third body 621C, a third protrusion part 623C extending upward in the axial direction from an end portion of the third extension part 622C, and a plurality of third terminal holes 624C formed to pass therethrough in the axial direction in the third body 621C. In addition, the third terminal 620C may further include a third boss part 625C extending the third terminal hole 624C in the axial direction.

The third body 621C may be formed in an arc shape with a predetermined third radius R3. Therefore, the one end portion and the other end portion of the third body 621C may be disposed to be spaced apart from each other with respect to the circumferential direction. Here, the third radius R3 may be a distance from the center C to an outer surface of the third body 621C and may be referred to as the third radius. In addition, the third radius R3 is smaller than the second radius R2.

In addition, the third body 621C may be surrounded by the bus bar holder 610.

The third extension part 622C may be disposed to extend inward in the radial direction from the one end portion of the third body 621C. In this case, the third extension part 622C may be formed to have a third length D3. In addition, the third length D3 is smaller than the second length D2. Therefore, the radial length D2 of the second extension part 622B may be smaller than the radial length D1 of the first extension part 622A and larger than the radial length D3 of the third extension part 622C.

The third protrusion part 623C may be formed to protrude upward in the axial direction from the one end portion of the third extension part 622C. Therefore, the third protrusion part 623C may be disposed to overlap a portion of the third extension part 622C in the axial direction. Here, the third protrusion part 623C may be referred to as a third terminal part.

Three third terminal holes 624C may be formed in the third body 621C. In addition, a portion of the coil 330 may be disposed to pass through the third terminal hole 624C inside the third terminal hole 624C.

The third boss part 625C may be formed to protrude from an upper surface of the third body 621C. The upper surface of the third body 621C may be one surface of the third body 621C disposed toward the cover 200.

Hereinafter, the arrangement relationship of the first terminal 620A, the second terminal 620B, and the third terminal 620C will be described with reference to FIGS. 6 and 7.

The bodies 621A, 621B, and 621C of the first terminal 620A, the second terminal 620B, and the third terminal 620C may be disposed to be spaced apart from each other from the outside to the center C with respect to the radial direction. In this case, the first body 621A, the second body 621B, and the third body 621C may be disposed on the same plane to reduce the axial size of the bus bar 600.

When viewed in the axial direction, the bodies 621A, 621B, and 621C of the first terminal 620A, the second terminal 620B, and the third terminal 620C may be formed in an arc shape. In addition, as illustrated in FIG. 7, the one end portion of the third body 621C may include an area which does not overlap the first body 621A and the second body 621B in the radial direction.

In addition, the upper and lower surfaces of the bodies 621A, 621B, and 621C of the first terminal 620A, the second terminal 620B, and the third terminal 620C may come into contact with the bus bar holder 610.

In addition, the second extension part 622B may be disposed between the first extension part 622A and the third extension part 622C with respect to the circumferential direction. In this case, since the first extension part 622A, the second extension part 622B, and the third extension part 622C have different lengths as described above, the first protrusion part 623A, the second protrusion part 623B, and the third protrusion part 623C may be disposed on the virtual circle CL.

In addition, the first protrusion part 623A, the second protrusion part 623B, and the third protrusion part 623C may be disposed not to overlap each other in the radial direction. In other words, each of the first protrusion part 623A, the second protrusion part 623B, and the third protrusion part 623C may be disposed at different radii with respect to the center C.

For example, the center C1 of the first protrusion part 623A may be disposed on a virtual first line L1, the center C2 of the second protrusion part 623B may be disposed on a virtual second line L2, and the center C3 of the third protrusion part 623C may be disposed on a virtual third line L3. Here, the first line L1 may be a virtual line connecting the center C to the center C1 of the first protrusion part 623A with respect to the radial direction, the second line L2 may be a virtual line connecting the center C to the center C2 of the second protrusion part 623B with respect to the radial direction, and the third line L3 may be a virtual line connecting the center to the center C3 of the third protrusion part 623C with respect to the radial direction. In this case, the first line L1, the second line L2, and the third line L3 may indicate different radial directions with respect to the center C.

In addition, the center C2 of the second protrusion part 623B may be disposed between the center C1 of the first protrusion part 623A and the center C3 of the third protrusion part 623C with respect to the circumferential direction.

In this case, an angle θ formed by the center C1 of the first protrusion part 623A and the center C2 of the second protrusion part 623B with respect to the center C may be equal to an angle θ formed by the center C2 of the second protrusion part 623B and the center C3 of the third protrusion part 623C.

Meanwhile, the plurality of first terminal holes 624A may be disposed not to overlap the second terminal hole 624B or the third terminal hole 624C with respect to the radial direction.

In addition, one of the plurality of first terminal holes 624A may be disposed to overlap the second extension part 622B of the second terminal 620B in the radial direction.

In addition, another one of the plurality of first terminal holes 624A may be disposed on the end portion of the first body 621A in the circumferential direction. In this case, the first terminal hole 624A disposed on the end portion of the first body 621A in the circumferential direction may overlap the second body 621B and the third body 621C in the radial direction.

FIG. 15 is a cross-sectional view illustrating a modified example of the terminal of the bus bar disposed on the motor according to the first embodiment.

Referring to FIG. 15, the boss part 625 may be disposed to protrude from the upper surface of the bus bar holder. Therefore, it is possible to increase a fixing strength of the boss part 625 and the coil 330 through fusing, welding, or the like.

The sensor unit 700 may detect the rotation of the shaft 500 by detecting a magnetic force of a sensing magnet installed to be rotationally interlocked with the rotor 400 to identify a current location of the rotor 400.

The sensor unit 700 may include a sensing magnet assembly 710 and a printed circuit board (PCB) 720.

The sensing magnet assembly 710 is coupled to the shaft 500 to be interworked with the rotation of the rotor 400 to detect the location of the rotor 400. In this case, the sensing magnet assembly 710 may include the sensing magnet and a sensing plate. The sensing magnet and the sensing plate may be coupled to have the same axis.

The sensing magnet may include a main magnet disposed adjacent to a hole forming an inner circumferential surface of the sensing plate in the circumferential direction, and a sub-magnet disposed at an edge of the sensing plate.

The main magnet may be arranged in the same manner as the magnet 420 of the rotor 400 of the motor.

The sub-magnet may be sub-divided more than the main magnet and may be formed to have more poles. Therefore, it is possible to divide the rotation angle more precisely of the rotor 400 through the sub-magnet and measure the rotation angle of the rotor 400, thereby more smoothly controlling the driving of the motor.

The sensing plate may be made of a metal material in a disk shape. The sensing magnet may be coupled to an upper surface of the sensing plate. In addition, the sensing plate may be coupled to the shaft 500. Here, a hole through which the shaft 500 passes is formed in the sensing plate.

A sensor for detecting the magnetic force of the sensing magnet may be disposed on the PCB 720. In this case, the sensor may be provided as a Hall IC. In addition, the sensor may generate a sensing signal by detecting a change in N and S poles of the sensing magnet.

### Second Embodiment

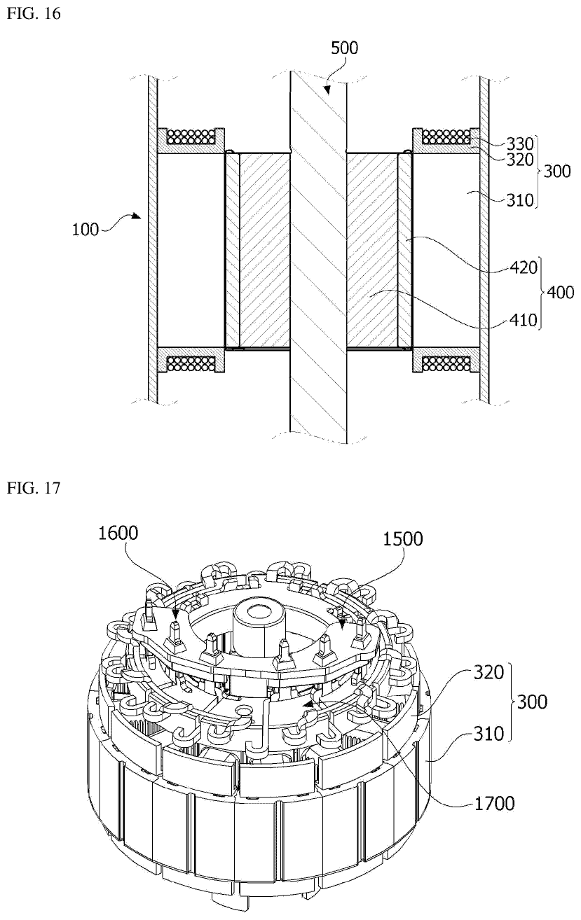

FIG. 16 is a view schematically illustrating the motor according to the embodiment.

Referring to FIG. 16, the motor according to the second embodiment may include a housing 100, a stator 300, a rotor 400, a shaft 500, and the like. Hereinafter, the inside indicates a direction from the housing 100 toward the shaft 500, which is the center of the motor, and the outside indicates a direction opposite to the inside, which is a direction from the shaft 500 to the housing 100. In addition, a radial direction below is based on the axial center of the shaft 500. The stator 300 and the rotor 400 are disposed inside the housing 100.

The stator 300 is disposed outside the rotor 400. The stator 300 may include a stator core 310, an insulator 320 mounted on the stator core 310, and a coil 330. The coil 330 may be wound around the insulator 320. The insulator 320 is disposed between the coil 330 and the stator core 310 and serves to electrically insulate the stator core 310 and the coil 330. The coil 330 causes the electrical interaction with a magnet of the rotor 400.

The rotor 400 is rotated by the electrical interaction with the stator 300. The rotor 400 may be disposed inside the stator 300.

The shaft 500 may be coupled to the rotor 400. When electromagnetic interaction occurs between the rotor 400 and the stator 300 through current supply, the rotor 400 rotates, and the shaft 500 rotates in conjunction with the rotation of the rotor 400.

FIG. 17 is a view illustrating the stator 300 on which a terminal 1600, a bus bar holder 1700, and a cap 1500 of the motor of according to the second embodiment are mounted.

An end portion of the terminal 1600 connected to an external device may pass through the housing 100 and may be exposed by protruding outward from the housing 100. The cap 1500 serves to prevent water or foreign substances from entering the housing 100, guide the end portion of the terminal 1600, and align a location of the end portion of the terminal 1600. The cap 1500 may be made of an insulating material.

Referring to FIG. 17, the bus bar holder 1700 is disposed above the insulator 320 of the stator 300. A plurality of terminals 1600 are fixed to the bus bar holder 1700. Some of the plurality of terminals 1600 may be neutral terminals 1600, and the other terminals 1600 may be three terminals 1600 with U, V, and W phases. The cap 1500 may be disposed above the terminal 1600 and connected to the end portion of the terminal 1600.

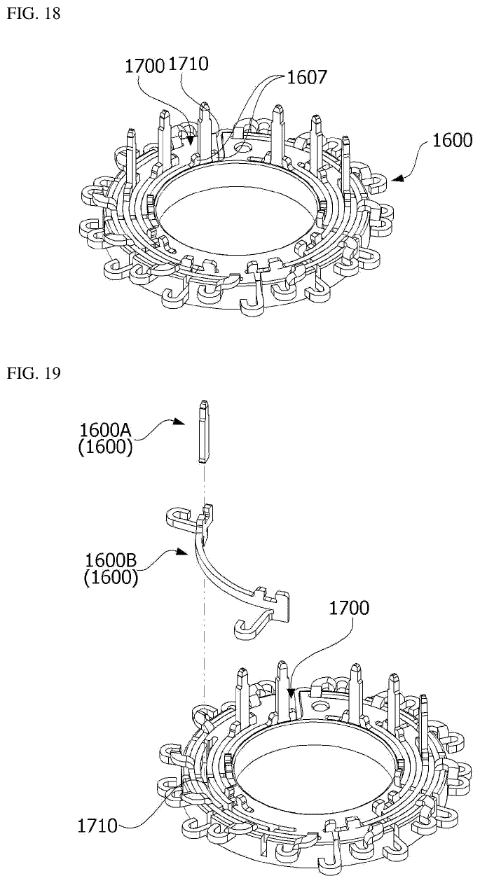

FIG. 18 is a perspective view illustrating the terminal 1600 and the bus bar holder 1700 of the motor according to the second embodiment, and FIG. 19 is a view illustrating the terminal 1600 mounted on the bus bar holder 1700 of the motor according to the second embodiment.

Referring to FIGS. 18 and 19, the terminal 1600 may be assembled to the bus bar holder 1700. The bus bar holder 1700 may include a plurality of slots 1710 concavely formed on an upper surface thereof in the drawings. A plurality of terminals 1600 may each be inserted into the slot 1710. Although it has been illustrated in the drawings that the terminal 1600 is assembled to the bus bar holder 1700, the present invention is not limited thereto, and the terminal 1600 and the bus bar holder 1700 may be injection-molded integrally.

The terminal 1600 may include a first body part 1600A and a second body part 1600B. The first body part 1600A and the second body part 1600B are separate products and may be coupled through welding. Here, the first body part 1600A may correspond to the protrusion part 623 of the motor according to the first embodiment, and the second body part 1600B may correspond to the body 621 of the motor according to the first embodiment. Therefore, the body 621 and the protrusion part 623 of the motor according to the first embodiment may be formed of two members, a groove G may be formed in the body 621, and the protrusion part may be coupled to the groove G formed in the body 621.

In addition, the terminal 1600 including the first body part 1600A and the second body part 1600B may correspond to the three terminals 1600 with the U, V, and W phases. The first body part 1600A comes into contact with the coil, and the second body part 1600B is connected to an external device. Shapes of the terminals 1600 may be the same.

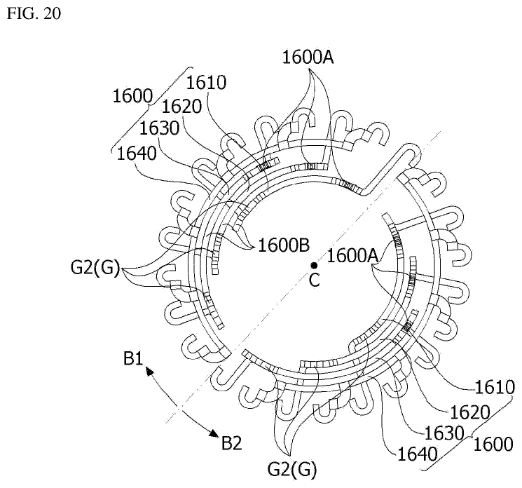

FIG. 20 is a plan view illustrating terminals 1600 disposed on the motor according to the second embodiment.

Referring to FIG. 20, the plurality of terminals 1600 may include a first terminal 1610, a second terminal 1620, a third terminal 1630, and a fourth terminal 1640. The first terminal 1610, the second terminal 1620, and the third terminal 1630 may correspond to phase terminals, and the fourth terminal 1640 may correspond to a neutral terminal.

The first terminal 1610, the second terminal 1620, and the third terminal 1630 unlike the fourth terminal 1640 may each include the first body part 1600A and the second body part 1600B.

The terminal 1600 may be classified into a first group B1 and a second group B2. The first group B1 and the second group B2 each include the first terminal 1610, the second terminal 1620, the third terminal 1630, and the fourth terminal 1640. The first group B1 and the second group B2 are configured to be separated in circuitry. The first group B1 and the second group B2 may be disposed to be spatially separated.

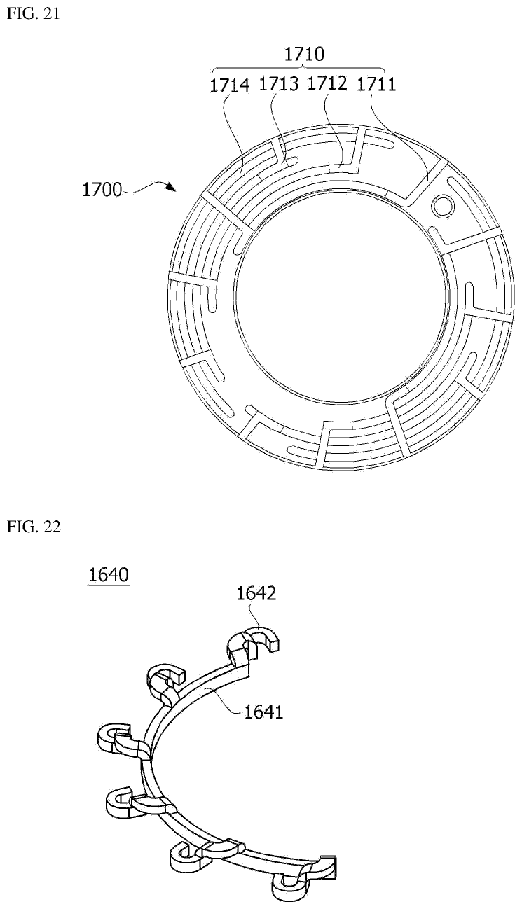

FIG. 21 is a plan view of the bus bar holder 1700 disposed on the motor according to the second embodiment.

Referring to FIGS. 20 and 21, the bus bar holder 1700 may be an annular member. A plurality of slots 1710 may be disposed in one surface of the bus bar holder 1700. The slot 1710 is a space for accommodating the terminal 1600. The slot 1710 may include a first slot 1711, a second slot 1712, a third slot 1713, and a fourth slot 1714.

The first terminal 1610 is disposed in the first slot 1711. The second terminal 1620 is disposed in the second slot 1712. The third terminal 1630 is disposed in the third slot 1713. The fourth terminal 1640 is disposed in the fourth slot 1714.

A portion of each of the slots 1710 is formed to extend to an outer circumferential surface of the bus bar holder 1700 to guide the end portion of the terminal 1600 in contact with the coil 330 to the outside of the bus bar holder 1700.

FIG. 22 is a view illustrating the fourth terminal 1640 of the motor according to the second embodiment.

Referring to FIG. 22, the fourth terminal 1640, which is the neutral terminal 1600, may include a rounded terminal body 1641 and a plurality of terminal parts 1642 branched from the terminal body 1641.

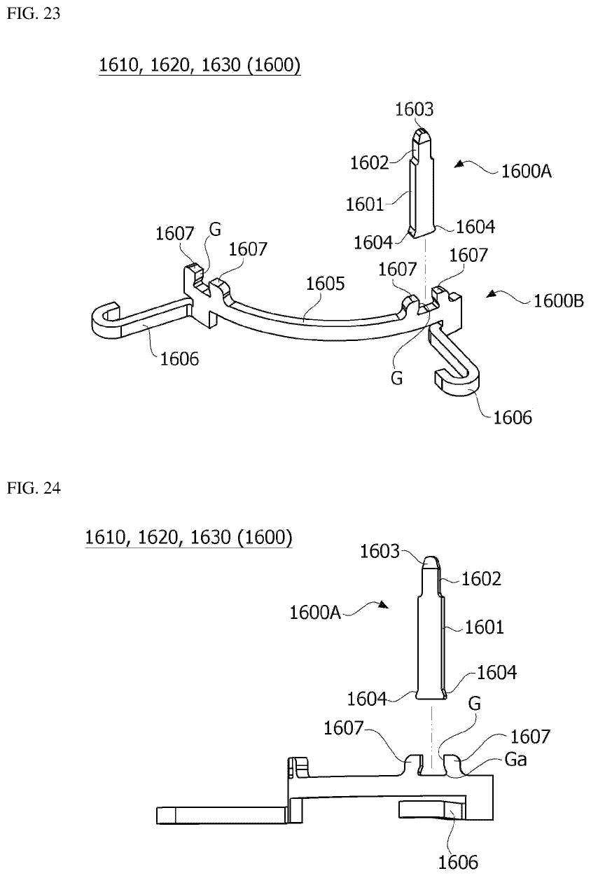

FIGS. 23 and 24 are views illustrating the first, second, and third terminals 1610, 1620, and 1630.

Referring to FIGS. 20, 23, and 24, the first terminal 1610, the second terminal 1620, and the third terminal 1630 may all have the same shape. Hereinafter, the terminal 1600 collectively indicates the first terminal 1610, the second terminal 1620, and the third terminal 1630.

The first terminal 1610 may include a straight middle portion 1601, an upper portion 1602 disposed above the middle portion 1601, a lower portion 1604 disposed under the middle portion 1601, and a tip portion 1603 disposed above the upper portion 1602. A portion of the middle portion 1601 is a portion passing through the cap 1500. The upper portion 1602 is a portion which is formed to have a smaller width than the middle portion 1601 and protruding upward from the cap 1500. The lower portion 1604 is a portion which is formed to have a larger width than the middle portion 1601 downward and coupled to the second terminal 1620 together with the portion of the middle portion 1601. The tip portion 1603 is formed to be sharper upward.

The second terminal 1620 may include an arc-shaped body 1605 and terminal parts 1606 bent outward at both end portions of the body 1605. The terminal part 1606 comes into contact with the coil 330. Protrusions 1607 may be disposed on the upper surface of the body 1605, and the protrusions 1607 may be disposed to be spaced apart from each other to form a space therebetween. The space between the protrusions 1607 is formed as a groove G to which the first body part 1600A is coupled. The first body part 1610A may be fixed to the second body part 1600B by being fitted into the groove G in the axial direction.

Referring to FIG. 18, the protrusion 1607 may be disposed to protrude from the one surface of the bus bar holder 1700.

Latching grooves Ga may be disposed on lower ends of both side walls of the groove G. The latching groove Ga is an area which is concavely formed on both side walls of the groove G and located so that a lower end of the first body part 1600A is caught. The lower end of the first body part 1600A is caught on the latching groove Ga to prevent the first body part 1600A from being separated from the groove G in the axial direction. The groove G may be disposed in each of both end portions of the body 1605.

In a state in which the first body part 1600A is fixed to the groove G of the second body part 1600B, a contact area between the first body part 1600A and the second body part 1600B may be welded to fix the first body part 1600A to the second body part 1600B.

Meanwhile, referring to FIG. 20, the grooves G of the plurality of terminals 1600 disposed in the first group B1 may be disposed not to overlap each other in the radial direction, and the grooves G of the plurality of terminals 1600 disposed in the second group B2 may be disposed not to overlap each other in the radial direction.

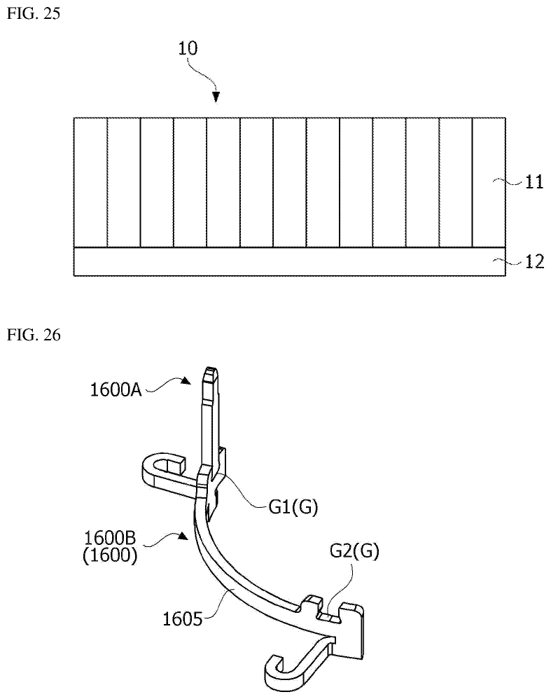

FIG. 25 is a view illustrating a plate for molding the terminal 1600.

Referring to FIG. 25, the terminal 1600 is manufactured by cutting a plate 10 and post-processing the cut plate 10. The plate 10 may be divided into a first part 11 forming the first body part 1600A and a second part 12 forming the second body part 1600B. The first part 11 is formed to extend in a vertical direction in the drawing, and a plurality of first parts 11 are arranged in a horizontal direction. The second part 12 is disposed at one side of the first part 11 and formed to extend in the horizontal direction.

As described above, since the first part 11 and the second part 12 are disposed linearly without a branching structure, it is possible to greatly reduce the scrap of the plate 10 discarded in the manufacturing process of the terminal 1600.

In particular, since shapes of the first body parts 1600A of the plurality of terminals 1600 are the same, it is possible to reduce the number of molds, thereby simplifying manufacturing equipment and manufacturing processes. When the second body parts 1600B of the plurality of terminals 1600 are designed to have the same shape and size, it is possible to further simplify manufacturing equipment and manufacturing processes.

In addition, since the first body parts 1600A are disposed linearly, it is possible to easily change the lengths of the first body parts 1600A according to conditions of the external device or design conditions of the terminal 1600.

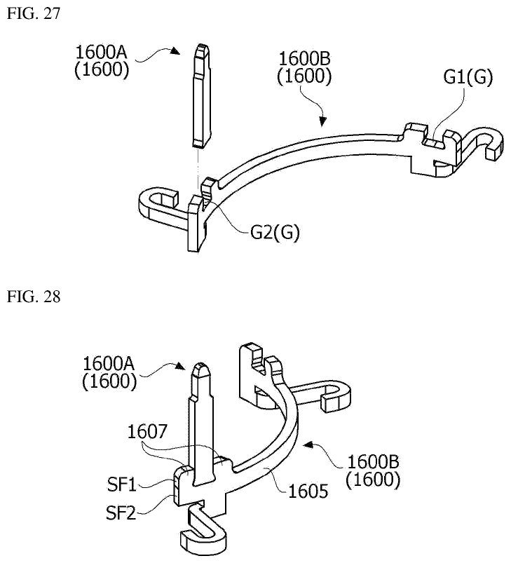

FIG. 26 is a view illustrating the terminal 1600 in which the first body part 1600A is disposed in a first groove, and FIG. 27 is a view illustrating the terminal 1600 in which the first body part 1600A is disposed in a second groove.

Referring to FIG. 26, the second body part 1600B may include a plurality of grooves G. For example, the groove G may include a first groove G1 and a second groove G2. The first groove G1 may be disposed in one end portion of the terminal body 1605. The second groove G2 may be disposed in the other end portion of the terminal body 1605. The first groove G1 and the second groove G2 have the same shape. In addition, the first groove G1 and the second groove G2 have the same size.

The first body part 1600A may be disposed in any one of the first groove G1 and the second groove G2 according to the design conditions of the terminal 1600. For example, when the first body part 1600A is coupled to the first groove G1, the second groove G2 may be empty. Referring to FIG. 27, the first body part 1600A may be coupled to the second groove G2 according to the design conditions of the terminal 1600. When the first body part 1600A is coupled to the second groove G2, the first groove G1 may be empty.

As described above, since the first body part 1600A with the same shape and size may be selectively coupled to any one of the first groove G1 and the second groove G2, the terminal 1600 can be shared. In other words, it is possible to design the terminal 1600 with the same components in response to the design conditions of the terminal 1600 required by various motors.

FIG. 28 is a perspective view of the terminal 1600 disposed on the motor according to the second embodiment viewed in another direction.

Referring to FIG. 28, one side surface SF1 of any one of a pair of protrusions 1607 and one side surface SF2 of the terminal body 1605 may be disposed on the same plane. In other words, by matching the one side surface SF2 of the protrusion 1607 with the one side surface SF1 of the terminal body 1605, it is possible to reduce the scrap generated due to a step between the one side surface SF2 of the protrusion 1607 and the one side surface SF1 of the terminal body 1605.

The motor according to the embodiments can be used, for example, in various devices for a vehicle or home appliance.

### DESCRIPTION OF REFERENCE NUMERALS

100: housing, 200: cover, 300: stator, 400: rotor, 500: shaft, 600: bus bar, 610, 1700: bus bar holder, 620, 1600: terminal, 621: body, 622: extension part, 623: protrusion part, 624: terminal hole, 625: boss part, 630: bus bar hole, 700: sensor unit, 1600A: first body part, 1600B: first body part, G: groove

1. A motor comprising:
a stator;
a rotor disposed inside the stator;
a shaft coupled to the rotor; and
a bus bar disposed on the stator,
wherein the bus bar includes a bus bar holder and a plurality of terminals disposed on the bus bar holder,
each of the terminals includes a body disposed in the bus bar holder, an extension part extending inward from the body, and a protrusion part protruding in an axial direction from an end portion of the extension part,
the body, the extension part, and the protrusion part are formed integrally,
the body and the extension part of each of the terminals are disposed on the same virtual plane, and
the protrusion part of each of the terminals is disposed to be exposed from the bus bar holder.

2. The motor of claim 1, wherein the bus bar includes a plurality of bus bar holes formed to pass therethrough in the axial direction, and
one area of a coil of the stator is disposed inside the bus bar hole.

3. The motor of claim 2, wherein each of the plurality of terminals includes the bus bar hole, and
the coil comes into contact with the terminal hole.

4. The motor of claim 3, wherein the terminal includes a boss part extending the terminal hole in the axial direction.

5. The motor of claim 4, wherein the boss part is disposed to protrude from an upper surface of the bus bar holder.

6. The motor of claim 1, wherein the protrusion part is disposed to overlap a portion of the extension part in the axial direction.

7. The motor of claim 1, wherein the plurality of terminals include a first terminal, a second terminal, and a third terminal disposed to be spaced apart from each other,
the first terminal includes an arc-shaped first body, a first extension part extending inward from the end portion of the first body, a first protrusion part extending from an end portion of the first extension part in the axial direction, and a plurality of first terminal holes formed in the first body,
the second terminal includes an arc-shaped second body, a second extension part extending inward from the end portion of the second body, a second protrusion part extending from an end portion of the second extension part in the axial direction, and a plurality of second terminal holes formed in the second body, and
the third terminal includes an arc-shaped third body, a third extension part extending inward from the end portion of the third body, a third protrusion part extending from an end portion of the third extension part in the axial direction, and a plurality of third terminal holes formed in the third body.

8. The motor of claim 7, wherein the second extension part is disposed between the first extension part and the third extension part with respect to a circumferential direction.

9. The motor of claim 8, wherein a radial length of the second extension part is smaller than a radial length of the first extension part and larger than a radial length of the third extension part.

10. The motor of claim 7, wherein a center of the first protrusion part, a center of the second protrusion part, and a center of the third protrusion part are disposed on a virtual circle (CL) with a predetermined radius (R) with respect to a center (C) of the bus bar.

11. The motor of claim 9, wherein an angle formed by a center (C1) of the first protrusion part and a center of the second protrusion part with respect to a center (C) of the bus bar is the same as an angle formed by the center of the second protrusion part and a center of the third protrusion part.

12. The motor of claim 7, wherein the bus bar includes a plurality of bus bar holes formed to pass therethrough in the axial direction,
the first terminal hole forms a portion of any one of the plurality of bus bar holes,
the second terminal hole forms a portion of another one of the plurality of bus bar holes, and
the third terminal hole forms a portion of the remaining one of the plurality of bus bar holes.

13. The motor of claim 7, wherein one of the plurality of first terminal holes is disposed to overlap the second extension part of the second terminal in the radial direction.

14. The motor of claim 13, wherein another one of the plurality of first terminal holes is disposed on the end portion of the first body in the circumferential direction.

15. The motor of claim 7, wherein the first terminal includes a first boss part extending the first terminal hole in the axial direction.

16. The motor of claim 7, wherein the first terminal hole does not overlap the second terminal hole or the third terminal hole with respect to the radial direction.

17. A motor comprising:
a shaft;
a rotor coupled to the shaft;
a stator disposed to correspond to the rotor and including a stator core, an insulator coupled to the stator core, and a coil disposed on the insulator; and
a terminal electrically connected to the coil,
wherein the terminal includes a first body part, and a second body part coupled to the first body part,
the second body part includes a plurality of grooves,
the first body part is coupled to any one of the plurality of grooves, and
the plurality of grooves have the same shape.

18. The motor of claim 17, wherein the second body part includes a terminal body, and terminal parts bent outward at both end portions of the terminal body and in contact with the coil,
the terminal body includes a pair of protrusions protruding from an upper surface of the terminal body, and
the groove is defined as a space between the pair of protrusions.
